(19) United States
(12) Patent Application Publication
(10) Pub. No.: US 2023/0359436 A1
(43) Pub. Date: Nov. 9, 2023

(54) FLOATING-POINT MULTIPLIER USING ZERO COUNTERS

(71) Applicant: SiFive, Inc., San Mateo, CA (US)

(72) Inventor: Nicolas Rémi Brunie, San Mateo, CA (US)

(21) Appl. No.: 18/191,095

(22) Filed: Mar. 28, 2023

Related U.S. Application Data
(60) Provisional application No. 63/338,622, filed on May 5, 2022.

(51) Int. Cl. G06F 7/487

(52) U.S. Cl. CPC G06F 7/487

(57) ABSTRACT

One or more zero counters may be configured to count trailing zeros of significands of operands to produce a trailing zero count from the first operand and the second operand. A round-bit position circuit may be configured to determine a predicted round-bit position of an expected significand multiplier result. The predicted round-bit position may be used to determine a trailing bit count indicating a number of bits that are less significant than a round-bit in the predicted round-bit position. A compare circuit may be configured to compare the trailing zero count to the trailing bit count to determine whether the expected significand multiplier result will cause a tie when rounding the expected significand multiplier result.

### CROSS-REFERENCE TO RELATED APPLICATION(S)

This application claims priority to and the benefit of U.S. Provisional Patent Application Ser. No. 63/338,622, filed May 5, 2022, the entire disclosure of which is hereby incorporated by reference.

### BACKGROUND

This disclosure relates generally to central processing units or processor cores and, more specifically, to configuring a floating-point multiplier using zero counters.

### TECHNICAL FIELD

A central processing unit (CPU) or processor core may implement a floating point unit (FPU). The FPU may be configured to execute floating-point (FP) arithmetic operations. For example, the FPU may execute FP arithmetic operations according to the IEEE Standard for Floating-Point Arithmetic (referred to as “the IEEE 754 standard”). The FPU may receive FP numbers as operands (e.g., inputs) and may perform an FP arithmetic operation using the operands to produce an FP number as a result (e.g., an output).

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of a floating-point multiplier (FMUL) using zero counters.

FIG. 2 is a block diagram of an example of prediction circuitry implemented in an FMUL.

FIG. 3 is an example of a significand of a first operand, a significand of a second operand, and an expected significand multiplier result.

FIG. 4 is a block diagram of an implementation of injection and mask circuitry implemented in an FMUL.

FIG. 5 is a block diagram of an example of rounding and update circuitry implemented in an FMUL using zero counters.

FIG. 6 is a flow chart of an example of a process for using an FMUL using zero counters.

FIG. 7 is a flow chart of an example of another process for using an FMUL using zero counters.

FIG. 8 is a flow chart of an example of another process for using an FMUL using zero counters.

FIG. 9 is a block diagram of an example of a system for facilitating generation and manufacture of integrated circuits.

FIG. 10 is a block diagram of an example of a system for facilitating generation of integrated circuits.

### DETAILED DESCRIPTION

A floating-point (FP) number may include significand bits (sometimes referred to as a mantissa, also referred to as “S” bits in an FP format), exponent bits, and a sign bit, which may be stored in a register and/or a memory location. The significand may be associated with an implicit bit, which may be a most significant bit that might not be stored in the register or the memory location. The FP number may have a precision associated with it that is specified by the FP format. For example, the double-precision floating-point format (sometimes referred to as FP64, binary64, or float64), specifies 53 significand bits (e.g., S bits, which may include 52 bits that are explicitly stored and 1 bit that is implicit), 11 exponent bits, and 1 sign bit, in a base-2 format (e.g., binary).

A floating point unit (FPU) implemented in an integrated circuit may include a floating-point multiplier (FMUL) configured to execute FP multiplication operations. The FMUL may receive operands in an FP format (e.g., FP64) and may perform an FP multiplication operation using the operands to produce a “final result” in the same FP format (e.g., FP64). To perform the FP multiplication, the FPU may perform an integer (INT) multiplication of the significands of the operands to produce a “significand multiplier result,” an addition of the exponents of the operands to produce a “result exponent,” and an exclusive-or (XOR) of the signs of the operands to determine a sign for the final result. However, multiplying the significands of the operands may produce a significand multiplier result that is twice as large as the significands of the operands (e.g., twice as many bits). For example, with FP64, multiplying the 53 significand bits of a first operand (e.g., S bits) by the 53 significand bits of a second operand (e.g., S bits) may produce a significand multiplier result having 106 significand bits (e.g., 2·S bits). To produce a final result in the same FP format as the operands, the FPU may round the significand multiplier result to produce a “significand rounded result” suitable for the FP format. For example, with FP64, the FPU may round the most significant bits of the 106 significand bits of the significand multiplier result (e.g., 2·S bits) to 53 significand bits for the significand rounded result (e.g., S bits).

“Rounding by injection” is a technique for rounding a significand multiplier result having more bits (e.g., 2·S bits) to produce a significand rounded result having fewer bits (e.g., S bits). When rounding by injection, an injection value (also referred to as an “auxiliary value”) is determined for the significand multiplier result, then the injection value is added to the significand multiplier result. The injection value may depend on the rounding mode to be used and the sign of the final result. For example, rounding modes may include rounding to a nearest value (also referred to as “rounding-to-nearest”), rounding towards zero (also referred to as “rounding-to-zero,” which may be accomplished by truncation), rounding towards positive or negative infinity (also referred to as “directed rounding towards positive or negative infinity”), and rounding away from zero, including as defined by the IEEE 754 standard. In some situations when rounding, a tie may occur where the significand multiplier result falls midway between two possible values for the significand rounded result (also referred to as a “tie-case”). This may be resolved according to a convention of the rounding mode, such as by rounding ties to an even value (e.g., a value having an even least significant bit, such as zero) (also referred to as to as “ties-to-even”). Also, in some situations, rounding the significand multiplier result may cause the significand rounded result to be “inexact,” meaning that the correct mathematical result is not representable exactly by the number of bits that are available (also referred to as an “inexact-case”). This may result in generating an exception flag that indicates that the significand rounded result is inexact.

In some situations, it may be desirable for the FMUL to detect a tie-case to produce a correct result. For example, if the least significant bit (LSB) that is more significant than a “round-bit” of a significand multiplier result were an even value (e.g., zero), then adding an injection value to round the significand multiplier result may produce a significand rounded result that is an odd value (e.g., the LSB of the significand rounded result may be one). The round-bit is a bit in a position in a significand multiplier result (e.g., having 2·S bits) that may correspond to a position that would be one bit less significant than the LSB of the significand rounded result (e.g., having S bits). The round-bit may be used for rounding the significand multiplier result (e.g., from 2·S bits) to produce the significand rounded result (e.g., to S bits). However, if the significand multiplier result were a tie-case, and the rounding mode specified ties-to-even, then the significand rounded result should be an even value (e.g., the LSB of the significand rounded result should be zero) and not an odd value (e.g., the LSB of the significand rounded result should not be one). This situation may be corrected by detecting that the significand multiplier result will cause a tie, then forcing the LSB of the significand rounded result to zero, regardless of its original value, responsive to detecting the tie.

A tie-case may be detected by extracting the round-bit and a “sticky field” from the significand multiplier result. For example, if the round-bit were zero, the nearest number for rounding the significand multiplier result may be the value of the S most significant bits of the significand multiplier result. If the round-bit were one, the nearest number for rounding the significand multiplier result may depend on the value of the sticky field. The sticky field may include the bits in positions that are less significant than the round-bit. If the round-bit is equal to 1 and the bits in the sticky field are zeros (e.g., which may be indicated by a sticky flag), a tie-case may be detected. The position of the round-bit in the significand multiplier result may depend on the most significant bit (MSB) of the significand multiplier result and the result exponent (e.g., the sum of the exponents of the operands). For significand multiplier results that are “normal” (e.g., numbers that start with a leading “1” instead of a leading “0” before the binary point or radix, which may include exponent), they may share a same relative position of their round-bit with respect to the MSB, such as an S+1 bit position (e.g., corresponding to a position that would be one bit less significant than the LSB of the significand rounded result having S bits). For significand multiplier results that are “sub-normal” (e.g., numbers that start with a leading “0” instead of a leading “1” before the binary point or radix while having a minimal exponent, such as a very small number), they may vary in the position of their round-bit with respect to the leading “1.”

However, there is some latency associated with the integer multiplication that is performed to produce the significand multiplier result. As a result, extracting the round-bit and the sticky field from the significand multiplier result for detecting a tie-case may be delayed due to the latency associated with the integer multiplication. Generally, it is desirable to reduce latencies in the FMUL where possible in order to improve calculation speed.

Implementations of this disclosure address problems such as these by speculating the position of a least significant non-zero bit of an expected significand multiplier result to determine whether the expected significand multiplier result will cause a tie. If the position of the least significant non-zero bit is less significant than a predicted round-bit position of an expected significand multiplier result, then a tie will not occur (e.g., the bits in the sticky field will not be consecutive zeros, but rather will comprise a non-zero value). However, the significand multiplier result will be inexact. If the position of the least significant non-zero bit is the same position as the predicted round-bit position, then a tie will occur (e.g., the round-bit will be equal to one and the bits in the sticky field will be zeros). Further, the significand multiplier result will be inexact. If the position of the least significant non-zero bit is more significant than the predicted round-bit position, then a tie will not occur. However, the significand multiplier result will be “exact,” meaning that the correct mathematical result is representable exactly by the number of bits that are available (also referred to as an “exact-case”).

The position of the least significant non-zero bit of the expected significand multiplier result may be determined by counting trailing zeros of the significands of the operands (e.g., adding together the consecutive zeroes in the least significant bit positions of the significands of the operands). The sum of trailing zeros of the significands of the operands may be referred to as a trailing zero count. In parallel, the predicted round-bit position of an expected significand multiplier result may be determined by summing the exponents of the operands (e.g., determining a “expected result exponent” that is a candidate exponent for the final result in the FP format). In some implementations, the operands and the final result may each be in a same FP format (e.g., a same precision). In some implementations, the operands may each be in a same FP format, and the final result may be in a different FP format (e.g., a different precision, different than the precision of the FP format of the operands). In some implementations, the operands may be in different FP formats (e.g., different precisions). The predicted round-bit position may be used to determine a trailing bit count indicating a number of bits that are less significant than the predicted round-bit position. The trailing zero count may be compared to the trailing bit count to determine whether the expected significand multiplier result will cause a tie, will not cause tie, will be exact, and/or will be inexact, when rounding the expected significand multiplier result. Comparing the trailing zero count to the trailing bit count bit does not involve computation of the significand multiplier result. Thus, the comparing may be performed in parallel with the integer multiplication that produces the significand multiplier result. As a result, latency in the FMUL may be reduced by determining whether the expected significand multiplier result will cause a tie before the significand multiplier result is calculated.

For example, executing the integer multiplication and routing the significand multiplier result may involve routing through a number of sequential gates in a data path. The gates may have timing delays associated with them, such as setup and hold times, which may limit the minimum period of a clock (e.g., a clock cycle). The number of gates that are in series in the data path may be referred to as a “logical depth.” To the extent that fewer gates may be used in the data path, and the logical depth reduced, the cumulative effect of timing delays associated with the gates in the data path may be reduced (e.g., the time for a signal to travel from a first clocked register to a second clocked register in a single clock cycle). This, in turn, may permit decreasing the period of the clock (or increasing the frequency of the clock) to improve the calculation speed. Thus, speculating the tie-case in parallel with computation of the significand multiplier result may permit fewer gates in the data path (e.g., a reduction of the logical depth) to permit improving the calculation speed.

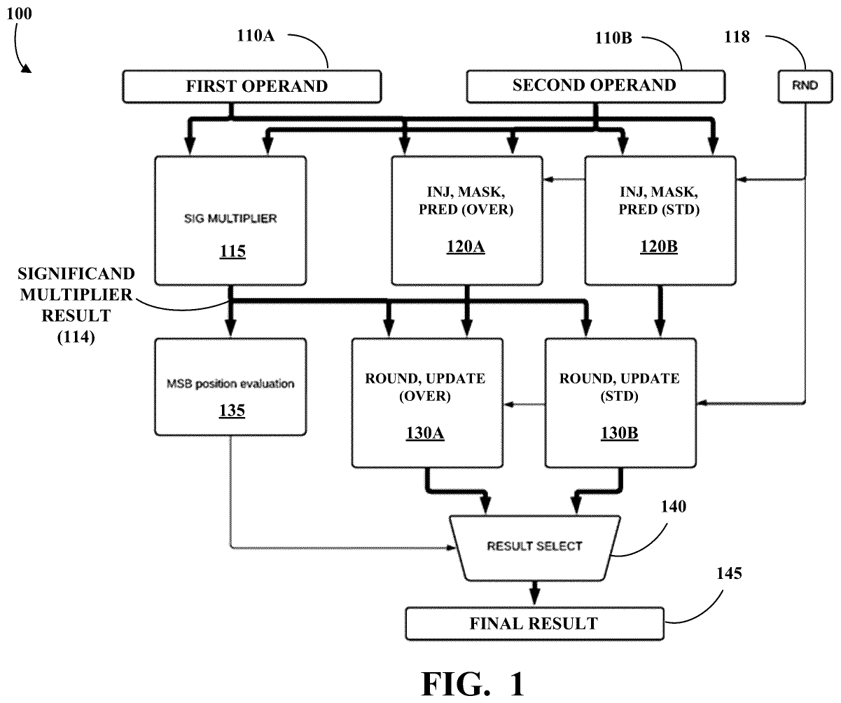

FIG. 1 is a block diagram of an example of an FMUL 100 using zero counters. The FMUL 100 may be implemented in an integrated circuit implementing a central processing unit (CPU) or processor core. The FMUL 100 may be implemented as part of a floating point unit (FPU). The FMUL 100 may be configured to execute FP multiplication operations. The FMUL 100 may receive a first operand 110A and a second operand 110B. The first operand 110A and the second operand 110B may be in a same FP format (e.g., FP64) or may be in different FP formats (e.g., the first operand 110A could be, for example, in the FP32 format, while the second operand 110B could be, for example, in the FP64 format). The FMUL 100 may perform an FP multiplication operation using the first operand 110A and the second operand 110B to produce a final result 145 in the same FP format (e.g., FP64) or in a different FP format. To perform the FP multiplication, the FMUL 100 may perform an integer (INT) multiplication of the significand of the first operand 110A by the significand of the second operand 110B to produce a significand multiplier result 114 (e.g., actual significand multiplier result, as opposed to an expected significand multiplier result that may be speculated). For example, the FMUL 100 may implement a significand multiplier 115 (e.g., in carry-save form) to perform the integer multiplication. The FMUL 100 may also perform an addition of the exponent of the first operand 110A with the exponent of the second operand 110B to produce a result exponent (not shown) for the final result 145. The FMUL 100 may also perform an exclusive-or (XOR) of the sign of the first operand 110A with the sign of the second operand 110B to determine a sign (not shown) for the final result 145.

However, multiplying the significand of the first operand 110A by the significand of the second operand 110B may cause the significand multiplier result 114 to be twice as large as the significand of the first operand 110A or the significand of the second operand 110B (e.g., twice as many bits). For example, with FP64, multiplying the 53 significand bits of the first operand 110A (e.g., S bits) by the 53 significand bits of the second operand 110B (e.g., S bits) may produce a significand multiplier result 114 having 106 significand bits (e.g., 2·S bits). To produce the final result 145, the FMUL 100 may round the significand multiplier result 114 to produce a significand rounded result suitable for the FP format. For example, with FP64, the FMUL 100 may round the most significant bits of the 106 significand bits of the significand multiplier result 114 (e.g., 2·S bits) to 53 significand bits for the significand rounded result (e.g., S bits).

For rounding, the FMUL 100 may implement rounding by injection for rounding the significand multiplier result 114 having more bits (e.g., 2·S bits) to produce the significand rounded result having fewer bits (e.g., S bits) the final result 145. When rounding by injection, an injection value is determined for the significand multiplier result 114, then the injection value is added to the significand multiplier result 114. The injection value may depend on a rounding mode 118 to be used and the sign of the final result 145. For example, the rounding mode 118 may select rounding-to-nearest, rounding-to-zero, directed rounding towards positive or negative infinity, and/or rounding-away-from-zero, including as defined by the IEEE 754 standard, and the injection value may be adjusted accordingly. Further, the rounding may include rounding with ties-to-even. In some implementations, the rounding may include rounding-to-odd. In some implementations, the rounding may include rounding with ties-to-odd. In some implementations, the rounding may include rounding with ties-away-from-zero.

In some implementations, the FMUL 100 may implement a partial dual path architecture that includes a “first data path” associated with an “overflow” case and a “second data path” associated with a “standard” case. The dual path architecture may permit speculating the significand multiplier result 114 (e.g., determining the expected significand multiplier result) without knowing the MSB position of the significand multiplier result 114. In some implementations, the first operand 110A and/or the second operand 110B may be in a “recoded” format, meaning the first operand 110A and the second operand 110B may be normalized with a one in the MSB position. In some implementations, the first operand 110A and/or the second operand 110B may be sub-normal with a leading “0” instead of a leading “1” before the binary point or radix while having a minimal exponent (e.g., the first operand 110A and/or the second operand 110B may be normalized sub-normal numbers). Based on the first operand 110A and the second operand 110B being normalized, the MSB of the significand multiplier result 114 may be assumed to be equal to one in the first data path (e.g., the overflow case) or may be assumed to be equal to zero in the second data path (e.g., the standard case). The FMUL 100 may implement MSB position circuitry 135 and result selection circuitry 140 to select between first data path (e.g., associated with an overflow case in which the MSB of the significand multiplier result 114 being equal to one) and the second data path (e.g., associated with a standard case in which the MSB of the significand multiplier result 114 being equal to zero) as discussed below.

For rounding by injection, the FMUL 100 may implement injection, mask, and prediction circuitry in the first data path and in the second data path, such as injection, mask, and prediction circuitry 120A in the first data path and injection, mask, and prediction circuitry 120B in the second data path. The injection, mask, and prediction circuitry may provide separate outputs corresponding to the first data path and the second data path to rounding and update circuitry that is also in the first data path and in the second data path. For example, the rounding and update circuitry may include rounding and update circuitry 130A in the first data path and rounding and update circuitry 130B in the second data path. That is, the rounding and update circuitry 130A may be used for rounding in the overflow case, and the rounding and update circuitry 130B may be used for rounding in the standard case. Thus, the rounding and update circuitry may provide separate outputs corresponding to the first data path and the second data path to the result selection circuitry 140 (e.g., a multiplexor). The FMUL 100 may implement the MSB position circuitry 135 to select between the separate outputs provided to the result selection circuitry 140 for providing the significand rounded result to be used for the final result 145. The MSB position circuitry 135 may select the output to correspond to the first data path (e.g., associated with the overflow case, using the injection, mask, and prediction circuitry 120A and the rounding and update circuitry 130A) or the second data path (associated with the standard case, using the injection, mask, and prediction circuitry 120B and the rounding and update circuitry 130B) based on the MSB of the significand multiplier result 114.

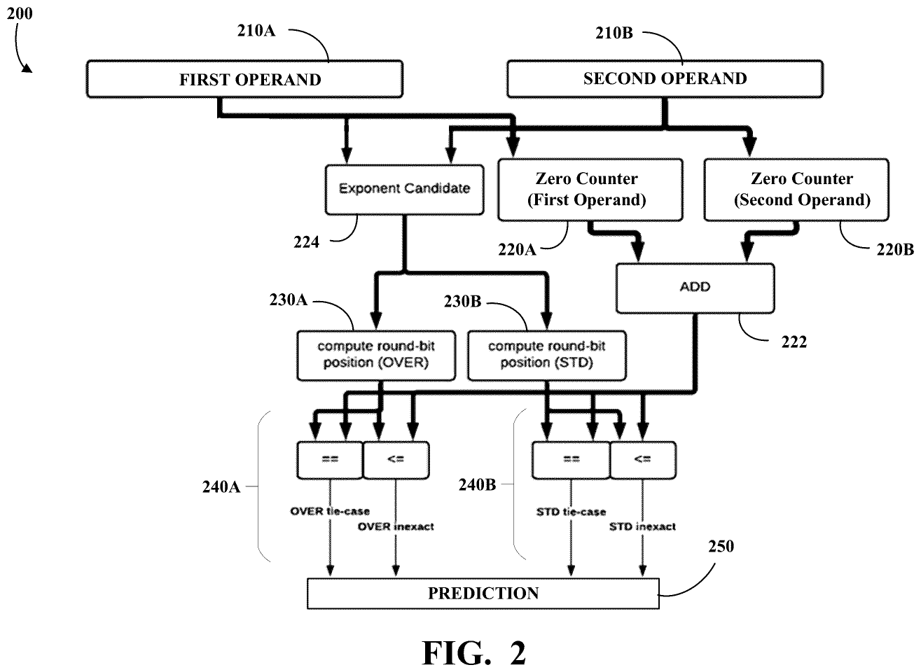

FIG. 2 is a block diagram of an example of prediction circuitry 200 implemented in an FMUL. The prediction circuitry 200 may be implemented in an FMUL like the FMUL 100 shown in FIG. 1. For example, the prediction circuitry 200 may be implemented by the injection, mask, and prediction circuitry of the FMUL 100, such as by the injection, mask, and prediction circuitry 120A and the prediction circuitry 120B. The prediction circuitry 200 may include one or more trailing zero counters, such as a zero counter 220A and a zero counter 220B. The zero counter 220A may be configured to count trailing zeros of a significand of a first operand 210A (e.g., like the significand of the first operand 110A shown in FIG. 1), and the trailing counter 220B may be configured to count trailing zeros of a significand of a second operand 210B (e.g., like the significand of the second operand 110B shown in FIG. 1). An adder 222 may sum the trailing zeros of the significand of the first operand 210A with the trailing zeros of the significand of the second operand 210B (e.g., from the one or more zero counters, adding together the consecutive zeroes in the least significant bit positions of the significand of the first operand 210A and the significand of the second operand 210B). Adding trailing zeros of the significand of the first operand 210A with trailing zeros of the significand of the second operand 210B may produce a trailing zero count.

In some implementations, the prediction circuitry 200 may implement predictions in the first data path associated with the overflow case and in the second data path associated with the standard case. The prediction circuitry 200 may include round-bit position circuits in the first data path and in the second data path, such as a round-bit position circuit 230A in the first data path (e.g., implemented in the injection, mask, and prediction circuitry 120A) and a round-bit position circuit 230B in the second data path (e.g., implemented in the injection, mask, and prediction circuitry 120B). In parallel with determining the trailing zero count, the round-bit position circuits may be configured to determine predicted round-bit positions of an expected significand multiplier result produced by an integer multiplication of the significand of the first operand 210A by the significand of the second operand 210B in the first data path and in the second data path. For example, the round-bit position circuit 230A may determine a predicted round-bit position of an expected significand multiplier result in the first data path, and the round-bit position circuit 230B may determine a predicted round-bit position of an expected significand multiplier result in the second data path. The predicted round-bit position may be determined by removing the exponent bias of the first operand 210A, removing the exponent bias of the second operand 210B, and summing an exponent of the first operand 210A (unbiased) with an exponent of the second operand 210B (unbiased). For example, an exponent of an operand may be “biased” when the operand is in the standard IEEE encoding or in a recoded format. For example, an adder and/or subtractor may be used to remove the exponent bias of the first operand 210A, remove the exponent bias of the second operand 210B, and sum the exponent of the first operand 210A (unbiased) with the exponent of the second operand 210B (unbiased) to produce an expected result exponent 224 that is a candidate exponent for the final result in the FP format (e.g., for the final result 145). The predicted round-bit position may then be determined by comparing the sum (e.g., the sum of the unbiased exponent of the first operand 210A with the unbiased exponent of the second operand 210B) to a value that is dependent on the FP format being used (e.g., the minimal exponent of a normal number). Depending on the result of this comparison, the round-bit position may be the sum (e.g., the actual, unbiased summed value) or a fixed, static value. In some implementations, the predicted round-bit position may be determined by comparing the sum of biased operands (e.g., the sum of the biased exponent of the first operand 210A with the biased exponent of the second operand 210B) to a biased value that is dependent on the FP format being used (e.g., the minimal exponent of a normal number). The expected result exponent 224 may be provided to the round-bit position circuits for determining the predicted round-bit positions in the first data path and in the second data path. The predicted round-bit positions may be used to determine trailing bit counts indicating a number of bits that are less significant than the predicted round-bit position. For example, the round-bit position circuit 230A may use the predicted round-bit position to determine a trailing bit count indicating a number of bits that are less significant than the predicted round-bit position in the first data path, and the round-bit position circuit 230B may use the predicted round-bit position to determine a trailing bit count indicating a number of bits that are less significant than the predicted round-bit position in the second data path.

The prediction circuitry 200 may also include compare circuits in the first data path and in the second data path, such as a compare circuit 240A in the first data path (e.g., implemented in the injection, mask, and prediction circuitry 120A) and a compare circuit 240B in the second data path (e.g., implemented in the injection, mask, and prediction circuitry 120B). The compare circuits may be configured to compare trailing zero counts (e.g., from the one or more zero counters) to trailing bit counts (e.g., from the round-bit position circuits) to determine a prediction 250 of whether the expected significand multiplier result will cause a tie, will not cause tie, will be exact, and/or will be inexact, in the first data path and the second data path, when rounding the expected significand multiplier result. For example, the compare circuit 240A may compare the trailing zero count to the trailing bit count to determine whether the expected significand multiplier result will cause a tie, will not cause tie, will be exact, and/or will be inexact when rounding to provide a prediction in the first data path. The compare circuit 240B may compare the trailing zero count to the trailing bit count to determine whether the expected significand multiplier result will cause a tie, will not cause tie, will be exact, and/or will be inexact when rounding to provide a prediction in the second data path. In some implementations, determining that the expected significand multiplier result will be inexact may generate an inexact exception flag.

The trailing zero count permits speculating the position of the least significant non-zero bit of the expected significand multiplier result. The trailing bit count permits speculating the round-bit position of the expected significand multiplier result. If the position of the least significant non-zero bit is less significant than the predicted round-bit position of the expected significand multiplier result (e.g., the trailing zero count is less than the trailing bit count), then the prediction 250 may indicate that a tie will not occur (e.g., the bits in the sticky field will not be consecutive zeros, but rather will comprise a non-zero value). Further, the prediction 250 may indicate that the expected significand multiplier result will be inexact. If the position of the least significant non-zero bit is the same position as the predicted round-bit position (e.g., the trailing zero count is equal to the trailing bit count), then the prediction 250 may indicate that a tie will occur (e.g., the round-bit will be equal to one and the bits in the sticky field will be zeros). Further, the prediction 250 may indicate that the expected significand multiplier result will be inexact. If the position of the least significant non-zero bit is more significant than the predicted round-bit position (e.g., the trailing zero count is greater than the trailing bit count), then the prediction 250 may indicate that a tie will not occur (e.g., the round-bit will be equal to one and the bits in the sticky field will be zeros). Further, the prediction 250 may indicate that the expected significand multiplier result will be exact.

Comparing the trailing zero counts (e.g., from the one or more zero counters) to the trailing bit counts (e.g., from the round-bit position circuits) does not involve computation of the significand multiplier result (e.g., does not involve computation by the significand multiplier result 114 to produce the actual significand multiplier result). Thus, the comparing performed by the compare circuits (e.g., the compare circuit 240A in the first data path and the compare circuit 240B in the second data path) may be done in parallel with the integer multiplication that produces the significand multiplier result (e.g., in parallel with the significand multiplier 115 computing the significand multiplier result 114). As a result, latency in the FMUL (e.g., the FMUL 100) may be reduced, such as by determining whether the expected significand multiplier result will cause a tie, and thereby determining whether the LSB of the significand rounded result should be forced to zero (e.g., ties-to-even, or forced to one for ties-to-odd), before the significand multiplier result is calculated.

In some implementations, the prediction circuitry 200 may include one or more zero counters configured to count the leading zeros of the significand of the first operand 210A and the leading zeros of the significand of the second operand 210B. This may be useful, for example, to count the leading zeros of a significand of an operand (e.g., the leading zeros of the significand of the first operand 210A and/or the leading zeros of the significand of the second operand 210B) when the operand is an IEEE 754 encoded format (as opposed to the recoded format). The IEEE 754 encoded format may also be referred to as “standard IEEE encoding.” For example, the zero counter 220A may be configured to count leading zeros of the first operand 210A (in addition to, or in place of, counting trailing zeros), and the zero counter 220A may be configured to count leading zeros of the second operand 210B (in addition to, or in place of, counting trailing zeros). The adder 222 may be configured to sum the leading zeros of the significand of the first operand 210A with the leading zeros of the significand of the second operand 210B (e.g., adding together the consecutive zeroes in the most significant bit positions of the significand of the first operand 210A and the significand of the second operand 210B). Adding the leading zeros of the significand of the first operand 210A with the leading zeros of the significand of the second operand 210B may be performed to produce a leading zero count. The leading zero count may permit speculating the position of an MSB of the significand multiplier result 114 when the first operand 210A and/or the second operand 210B are sub-normal numbers. This may permit, for example, determining the predicted round-bit position for the significand multiplier result 114 when the significand multiplier result 114 is a sub-normal number. In some implementations, the leading zero count (e.g., indicating leading zeros for both operands) and the trailing zero count (e.g., indicating trailing zeros for both operands) may be combined for determining whether the expected significand multiplier result will cause a tie when rounding, and/or for determining whether the expected significand multiplier result will be inexact when rounding, when the first operand 210A and/or the second operand 210B are sub-normal numbers. For example, the leading zero count (e.g., indicating leading zeros for both operands, either of which may be sub-normal) may be used to speculate the position of an MSB of the significand multiplier result 114. The position of the MSB, in turn, may be used with the trailing zero count (e.g., indicating trailing zeros for both operands, either of which may be sub-normal) to speculate a round-bit position for the significand multiplier result 114 (e.g., which may be sub-normal). The round-bit position, in turn, may be compared with the expected position of the least significant non-zero bit to determine whether the expected significand multiplier result will cause a tie when rounding, and/or to determine whether the expected significand multiplier result will be inexact when rounding. In some implementations, the leading zero count and the trailing zero count may be used to speculate the position of an MSB of the significand multiplier result 114 (e.g., which may be sub-normal) in a partial dual path architecture that includes a first data path associated with an overflow case and a second data path associated with a standard case.

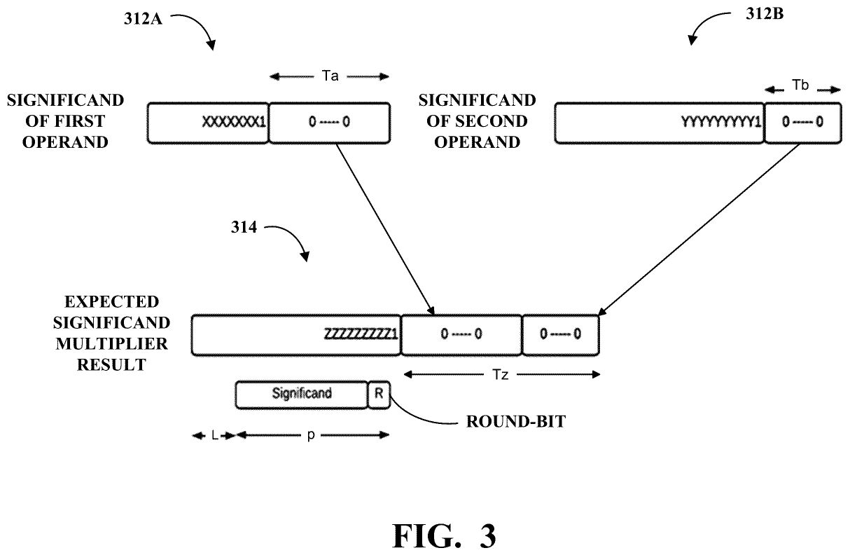

FIG. 3 is an example of a significand 312A of a first operand, a significand 312B of a second operand, and an expected significand multiplier result 314. For example, the significand 312A could be the significand of the first operand 110A shown in FIG. 1, and the significand 312B could be the significand of the second operand 110B shown in FIG. 1. The expected significand multiplier result 314 could be a prediction of the significand multiplier result 114 shown in FIG. 1, which could be predicted by the prediction circuitry 200 shown in FIG. 2. One or more zero counters may be configured to count trailing zeros (e.g., “Ta” and “Tb”) of the significand 312A and of the significand 312B to produce a trailing zero count. For example, the zero counter 220A shown in FIG. 2 may count trailing zeros (e.g., “Ta”) of the significand 312A, and the zero counter 220B shown in FIG. 2 may count trailing zeros (e.g., “Tb”) of the significand 312B. Adding the trailing zeros (e.g., “Ta”) of the significand 312A of the first operand with the trailing zeros (e.g., “Tb”) of the significand 312B of the second operand may produce the trailing zero count. The trailing zero count may represent a number of trailing zeros (e.g., “Tz”) of the expected significand multiplier result 314.

The expected significand multiplier result 314 may include “p” bits with “L” leading zeros and “Tz” trailing zeros (e.g., Tz=Ta+Tb). The p bits may depend on the exponent. For example, for a normal number, the p bits may correspond to the precision “S” of the FP format (e.g., for FP64, this may be 53 significand bits for double precision, and for FP32, this may be 24 significand bits for single precision). For a sub-normal number, the p bits may correspond to p=S+exponent−eMinNormal, where eMinNormal is the minimal exponent for a normal number in the FP format (e.g., −1022 for double precision, −126 for single precision). The p bits may have a minimal value of 1.

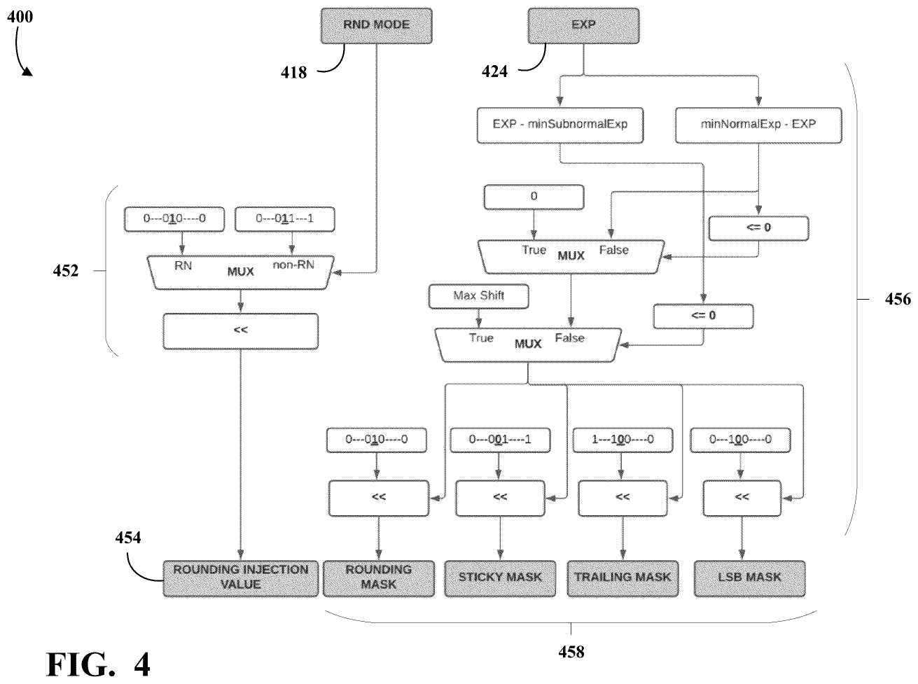

FIG. 4 is a block diagram of an implementation of injection and mask circuitry 400 implemented in an FMUL. The injection and mask circuitry 400 may be implemented in an FMUL like the FMUL 100 shown in FIG. 1. For example, a first instance of the injection and mask circuitry 400 may be implemented by the injection, mask, and prediction circuitry 120A in the first data path shown in FIG. 1 (e.g., associated with the overflow case). A second instance of the injection and mask circuitry 400 may be implemented by the injection, mask, and prediction circuitry 120B in the second data path shown in FIG. 1 (e.g., associated with the standard case). The injection and mask circuitry 400 may receive a rounding mode 418 like the rounding mode 118 shown in FIG. 1 (e.g., selection of rounding-to-nearest, rounding-to-zero, directed rounding towards positive or negative infinity, or rounding-away-from-zero). The injection and mask circuitry 400 may also receive an expected result exponent 424 like the expected result exponent 224 shown in FIG. 2 (e.g., a sum of an unbiased exponent of a first operand with an unbiased exponent of a second operand, which may be a candidate exponent for a final result in the FP format).

The injection and mask circuitry 400 may include an injection value circuit 452 configured to determine an injection value 454. The injection value 454 may be determined for rounding a significand multiplier result (e.g., the significand multiplier result 114) having more bits (e.g., 2·S bits) to produce a significand rounded result having fewer bits (e.g., S bits). The injection value 454 may be based on the rounding mode 418 that is selected. For example, for rounding-to-nearest, the injection value 454 may corresponds to half a unit in the last place (ULP). The injection value circuit 452 may include registers, multiplexors, and/or shifters for providing the injection value 454. The injection and mask circuitry 400 may also include a mask circuit 456 configured to produce one or more masks 458, such as a rounding mask, a sticky mask, a trailing mask, and/or an LSB mask. For example, the rounding mask may be used to extract a round-bit value in a round-bit position of a significand multiplier result. The sticky mask may be used to extract a sticky field value from the significand multiplier result. In some implementations, such as for significand multiplier results that are sub-normal, the trailing mask may be used to mask-off trailing bits in the recoded format. In some implementations, such as for significand multiplier results that are normal, the trailing bit fields may be statically determined without using the trailing mask. The LSB mask may be used to extract the significand LSB. The masks 458 may be based on the expected result exponent 424. The mask circuit 456 may include registers, multiplexors, and/or shifters for providing the rounding mask, the sticky mask, the trailing mask, and/or the LSB mask. Thus, the injection and mask circuitry 400 may be used for providing a first injection value and first masks in the overflow case (e.g., the first instance implemented by the injection, mask, and prediction circuitry 120A) and a second injection value and second masks in the standard case (e.g., the second instance implemented by the injection, mask, and prediction circuitry 120B).

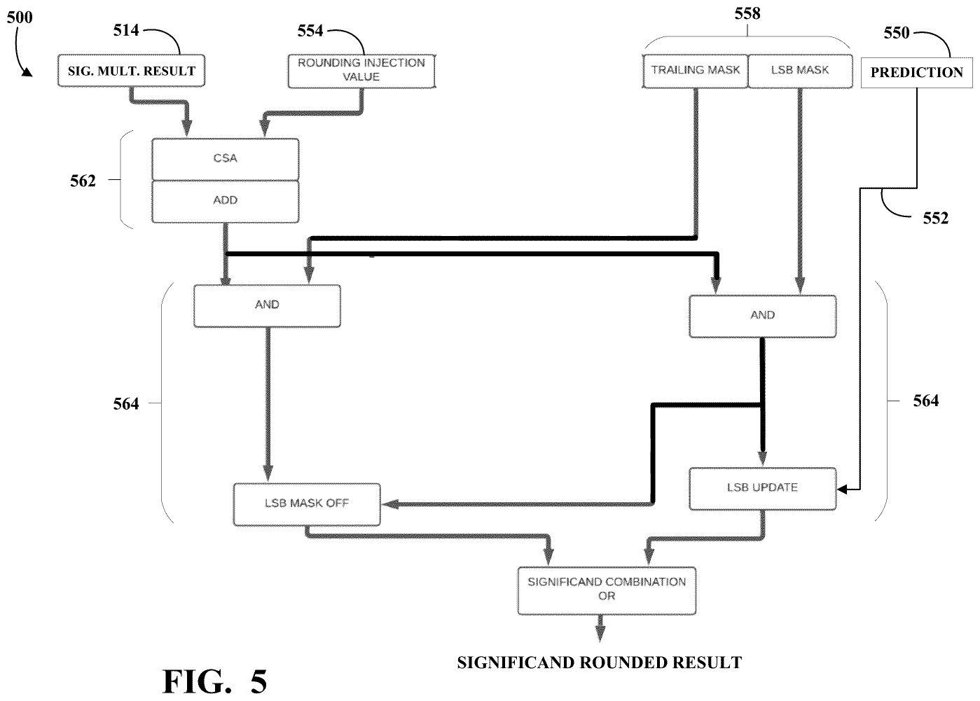

FIG. 5 is a block diagram of an example of rounding and update circuitry 500 implemented in an FMUL using zero counters. The rounding and update circuitry 500 may be implemented in an FMUL like the FMUL 100 shown in FIG. 1. For example, a first instance of the rounding and update circuitry 500 may be implemented by the rounding and update circuitry 130A in the first data path shown in FIG. 1 (e.g., associated with the overflow case). A second instance of the rounding and update circuitry 500 may be implemented by the rounding and update circuitry 130B in the second data path shown in FIG. 1 (e.g., associated with the standard case). The rounding and update circuitry 500 may receive a significand multiplier result 514 like the significand multiplier result 114 shown in FIG. 1. In some implementations, the significand multiplier result 114 may be in a redundant (e.g., carry-save) form. For example, the significand multiplier result 514 could be calculated by a significand multiplier like the significand multiplier 115 shown in FIG. 1. The rounding and update circuitry 500 may also receive an injection value 554 like the injection value 454 shown in FIG. 4. The rounding and update circuitry 500 may also receive masks 558, which may include one or more of the masks 458 shown in FIG. 4, such as the trailing mask and the LSB mask. The rounding and update circuitry 500 may also receive a prediction 550 like the prediction 250 shown in FIG. 2.

The rounding and update circuitry 500 may include a rounding circuit 562. The rounding circuit 562 may receive the injection value 554 and the significand multiplier result 514. The rounding circuit 562 may add the injection value 554 to the significand multiplier result 514 to produce a significand rounded result. The rounding and update circuitry 500 may also include an LSB update circuit 564. The LSB update circuit 564 may update the LSB of the significand rounded result (e.g., from the rounding circuit 562) when a compare circuit (e.g., the compare circuit 240A in the first data path or the compare circuit 240B in the second data path) determines that the expected significand multiplier result will cause a tie. The update of the LSB of the significand rounded result may be based on the prediction 550 and the masks 558 (e.g., the trailing mask and the LSB mask). As a result, latency may be reduced, such as by determining whether the expected significand multiplier result will cause a tie, and thereby providing an indication 552 as to whether the LSB update circuit 564 should force the LSB of the significand rounded result to zero, before the significand multiplier result 514 is calculated (e.g., before the rounding circuit 562 adds the injection value 554 to the significand multiplier result 514). For example, there may be some latency associated with the integer multiplication that is performed (e.g., by the significand multiplier 115 shown in FIG. 1) to produce the significand multiplier result 514. This effect of this delay may be reduced by comparing the trailing zero count to the trailing bit count bit (e.g., by prediction circuitry like the prediction circuitry 200 shown in FIG. 2) to produce the prediction 550 in parallel with the integer multiplication that produces the significand multiplier result 514. Generating the prediction 550 does not involve computation of the significand multiplier result 514. As a result, latency in the FMUL may be reduced by determining whether the expected significand multiplier result will cause a tie before the significand multiplier result 514 is calculated.

For example, executing the integer multiplication and routing the significand multiplier result 514 may involve routing through a number of sequential gates in a data path. The gates may have timing delays associated with them, such as setup and hold times, which may limit the minimum period of a clock (e.g., a clock cycle). To the extent that fewer gates may be used in the data path, and the logical depth reduced, the cumulative effect of timing delays associated with the gates in the data path may be reduced (e.g., the time for a signal to travel from a first clocked register to a second clocked register in a single clock cycle). This, in turn, may permit decreasing the period of the clock (or increasing the frequency of the clock) to improve the calculation speed. By comparing the trailing zero count to the trailing bit count bit (e.g., by prediction circuitry like the prediction circuitry 200 shown in FIG. 2) to produce the prediction 550 in parallel with the integer multiplication that produces the significand multiplier result 514, fewer gates may be used in the path associated with the LSB update circuit 564, and the logical depth may be reduced. In other words, the LSB update circuit 564 may receive the prediction 550 (and the masks 558) in parallel with receiving the significand multiplier result 514. The LSB update circuit 564 may avoid waiting for the significand multiplier result 514 for determining whether to update the LSB of the significand rounded result (e.g., which might correspond to more gates and/or a greater logical depth). Thus, the minimum period of a clock may be reduced, based on reducing the cumulative effect of the timing delays, to permit a greater calculation speed.

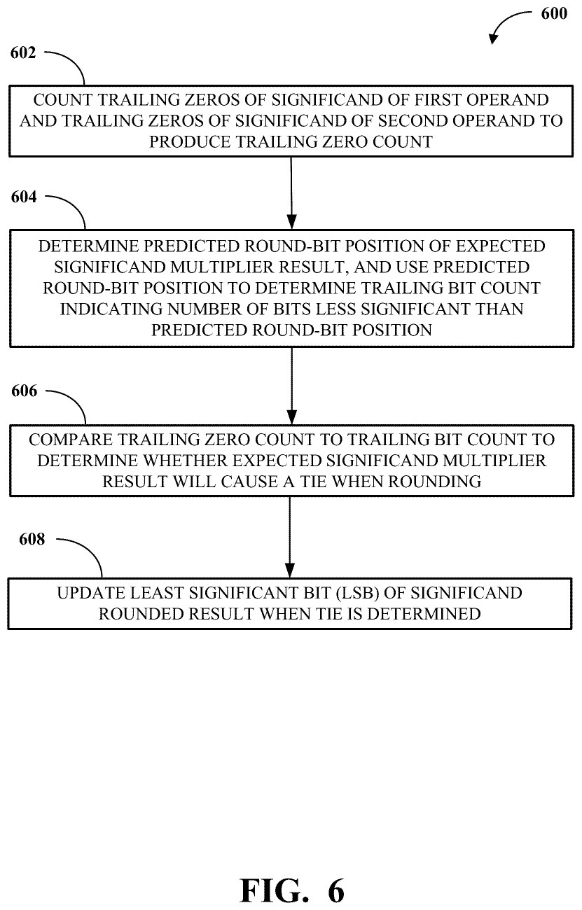

FIG. 6 is a flow chart of an example of a process 600 for using an FMUL using zero counters. The process 600 can be performed, for example, using the systems, hardware, and software described with respect to FIGS. 1-5. The steps, or operations, of the process 600 or another technique, method, process, or algorithm described in connection with the implementations disclosed herein can be implemented directly in hardware, firmware, software executed by hardware, circuitry, or a combination thereof. Further, for simplicity of explanation, although the figures and descriptions herein may include sequences or series of steps or stages, elements of the methods and claims disclosed herein may occur in various orders or concurrently and need not include all of the steps or stages. Additionally, elements of the methods and claims disclosed herein may occur with other elements not explicitly presented and described herein. Furthermore, not all elements of the methods and claims described herein may be required in accordance with this disclosure. Although aspects, features, and elements are described and claimed herein in particular combinations, each aspect, feature, or element may be used and claimed independently or in various combinations with or without other aspects, features, and elements.

The process 600 may include counting 602 trailing zeros of a significand of a first operand and trailing zeros of a significand of a second operand to produce a trailing zero count from the first operand and the second operand. For example, the prediction circuitry (e.g., the prediction circuitry 200) may include one or more zero counters configured to count trailing zeros of a significand of a first operand (e.g., the first operand 210A) and count trailing zeros of a significand of a second operand (e.g., the second operand 210B). An adder may sum the trailing zeros of the significand of the first operand with the trailing zeros of the significand of the second operand to produce a trailing zero count. The trailing zero count may be determined in parallel with the integer multiplication that produces the significand multiplier result (e.g., the significand multiplier result 114, calculated by significand multiplier 115).

In some implementations, the prediction circuitry may include one or more zero counters configured to count the leading zeros of a significand of a first operand and the leading zeros of a significand of a second operand. An adder may sum the leading zeros of the significand of the first operand with the leading zeros of the significand of the second operand to produce a leading zero count. The leading zero count may be determined in parallel with the integer multiplication that produces the significand multiplier result. In some implementations, the counters may be implemented in a partial dual path architecture that includes a first data path associated with an overflow case and a second data path associated with a standard case.

The process 600 may also include determining 604 a predicted round-bit position of an expected significand multiplier result produced by an integer multiplication of the significand of the first operand by the significand of the second operand. The predicted round-bit position may be used to determine a trailing bit count indicating a number of bits that are less significant than the predicted round-bit position. For example, the prediction circuitry may include a round-bit position circuit. The round-bit position circuit may be used to predict the round-bit position of an expected significand multiplier result by removing the exponent bias of the first operand, removing the exponent bias of the second operand, and summing an exponent of the first operand (unbiased) with an exponent of the second operand (unbiased). For example, an adder and/or subtractor may be used to remove the exponent bias of the first operand, remove the exponent bias of the second operand, and sum the exponent of the first operand (unbiased) with the exponent of the second operand (unbiased) to produce an expected result exponent that is a candidate exponent for a final result in the FP format (e.g., for the final result 145). The expected result exponent may be provided to the round-bit position circuit for determining the predicted round-bit position. The predicted round-bit positions may be used to determine a trailing bit count indicating a number of bits that are less significant than the predicted round-bit position.

The predicted round-bit position and the trailing bit count may be determined in parallel with the integer multiplication that produces the significand multiplier result (e.g., the significand multiplier result 114, calculated by significand multiplier 115). The predicted round-bit position and the trailing bit count may also be determined in parallel with determining the trailing zero count (and/or the leading zero count). In some implementations, round-bit position circuits may be implemented in the dual path architecture that includes the first data path associated with the overflow case and the second data path associated with the standard case.

The process 600 may also include comparing 606 the trailing zero count to the trailing bit count to determine whether the expected significand multiplier result will cause a tie when rounding. For example, the prediction circuitry may include compare circuits configured to compare trailing zero counts (e.g., from the one or more zero counters) to trailing bit counts (e.g., from the round-bit position circuit) to determine a prediction (e.g., the prediction 250) of whether the expected significand multiplier result will cause a tie, will not cause tie, will be exact, and/or will be inexact. In some implementations, compare circuits may be implemented in the dual path architecture that includes the first data path associated with the overflow case and the second data path associated with the standard case. The comparing may be performed in parallel with the integer multiplication that produces the significand multiplier result (e.g., the significand multiplier result 114, calculated by significand multiplier 115). By comparing in parallel with the integer multiplication (e.g., calculation of the actual significand multiplier result), latency in the FMUL (e.g., the FMUL 100) may be reduced. For example, comparing the trailing zero count to the trailing bit count bit in parallel with the integer multiplication may permit fewer sequential gates to be used (e.g., the logical depth reduced). This, in turn, may permit the minimum period of a clock used by the FMUL to be reduced to allow a greater calculation speed (e.g., a higher clock frequency).

The process 600 may also include updating 608 the LSB of a significand rounded result when the tie is determined. For example, a rounding circuit (e.g., the rounding circuit 562) may receive an injection value and the significand multiplier result (e.g., the significand multiplier result 114, calculated by significand multiplier 115). The rounding circuit may add the injection value to the significand multiplier result to produce a significand rounded result. An LSB update circuit (e.g., the LSB update circuit 564) may update the LSB of the significand rounded result when a compare circuit (e.g., the compare circuit 240A in the first data path or the compare circuit 240B in the second data path) determines that the expected significand multiplier result will cause a tie. For example, the update of the LSB of the significand rounded result may be based on a prediction (e.g., the prediction 550) and masks (e.g., the masks 558).

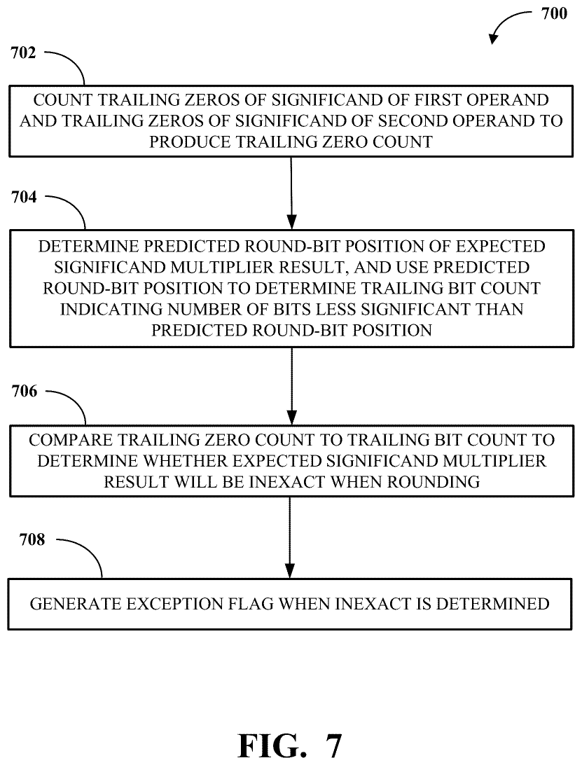

FIG. 7 is a flow chart of an example of another process 700 for using an FMUL using zero counters. The process 700 can be performed, for example, using the systems, hardware, and software described with respect to FIGS. 1-5. The steps, or operations, of the process 700 or another technique, method, process, or algorithm described in connection with the implementations disclosed herein can be implemented directly in hardware, firmware, software executed by hardware, circuitry, or a combination thereof. Further, for simplicity of explanation, although the figures and descriptions herein may include sequences or series of steps or stages, elements of the methods and claims disclosed herein may occur in various orders or concurrently and need not include all of the steps or stages. Additionally, elements of the methods and claims disclosed herein may occur with other elements not explicitly presented and described herein. Furthermore, not all elements of the methods and claims described herein may be required in accordance with this disclosure. Although aspects, features, and elements are described and claimed herein in particular combinations, each aspect, feature, or element may be used and claimed independently or in various combinations with or without other aspects, features, and elements.

The process 700 may include counting 702 trailing zeros of a significand of a first operand and trailing zeros of a significand of a second operand to produce a trailing zero count from the first operand and the second operand. For example, the prediction circuitry (e.g., the prediction circuitry 200) may include one or more zero counters configured to count trailing zeros of a significand of a first operand (e.g., the first operand 210A) and count trailing zeros of a significand of a second operand (e.g., the second operand 210B). An adder may sum the trailing zeros of the significand of the first operand with the trailing zeros of the significand of the second operand to produce a trailing zero count. The trailing zero count may be determined in parallel with the integer multiplication that produces the significand multiplier result (e.g., the significand multiplier result 114, calculated by significand multiplier 115).

In some implementations, the prediction circuitry may include one or more zero counters configured to count the leading zeros of a significand of a first operand and the leading zeros of a significand of a second operand. An adder may sum the leading zeros of the significand of the first operand with the leading zeros of the significand of the second operand to produce a leading zero count. The leading zero count may be determined in parallel with the integer multiplication that produces the significand multiplier result. In some implementations, the counters may be implemented in a partial dual path architecture that includes a first data path associated with an overflow case and a second data path associated with a standard case.

The process 700 may also include determining 704 a predicted round-bit position of an expected significand multiplier result produced by an integer multiplication of the significand of the first operand by the significand of the second operand. The predicted round-bit position may be used to determine a trailing bit count indicating a number of bits that are less significant than the predicted round-bit position. For example, the prediction circuitry may include a round-bit position circuit. The round-bit position circuit may be used to predict the round-bit position of an expected significand multiplier result by removing the exponent bias of the first operand, removing the exponent bias of the second operand, and summing an exponent of the first operand (unbiased) with an exponent of the second operand (unbiased). For example, an adder and/or subtractor may be used to remove the exponent bias of the first operand, remove the exponent bias of the second operand, and sum the exponent of the first operand (unbiased) with the exponent of the second operand (unbiased) to produce an expected result exponent that is a candidate exponent for a final result in the FP format (e.g., for the final result 145). The expected result exponent may be provided to the round-bit position circuit for determining the predicted round-bit position. The predicted round-bit positions may be used to determine a trailing bit count indicating a number of bits that are less significant than the predicted round-bit position.

The predicted round-bit position and the trailing bit count may be determined in parallel with the integer multiplication that produces the significand multiplier result (e.g., the significand multiplier result 114, calculated by significand multiplier 115). The predicted round-bit position and the trailing bit count may also be determined in parallel with determining the trailing zero count (and/or the leading zero count). In some implementations, round-bit position circuits may be implemented in the dual path architecture that includes the first data path associated with the overflow case and the second data path associated with the standard case.

The process 700 may also include comparing 706 the trailing zero count to the trailing bit count to determine whether the expected significand multiplier result will be inexact when rounding. For example, the prediction circuitry may include compare circuits configured to compare trailing zero counts (e.g., from the one or more zero counters) to trailing bit counts (e.g., from the round-bit position circuit) to determine a prediction (e.g., the prediction 250) of whether the expected significand multiplier result will cause a tie, will not cause tie, will be exact, and/or will be inexact. In some implementations, compare circuits may be implemented in the dual path architecture that includes the first data path associated with the overflow case and the second data path associated with the standard case. The comparing may be performed in parallel with the integer multiplication that produces the significand multiplier result (e.g., the significand multiplier result 114, calculated by significand multiplier 115). By comparing in parallel with the integer multiplication (e.g., calculation of the actual significand multiplier result), latency in the FMUL (e.g., the FMUL 100) may be reduced. For example, comparing the trailing zero count to the trailing bit count bit in parallel with the integer multiplication may permit fewer sequential gates to be used (e.g., the logical depth reduced). This, in turn, may permit the minimum period of a clock used by the FMUL to be reduced to allow a greater calculation speed (e.g., a higher clock frequency).

The process 700 may also include generating 708 an exception flag when the expected significand multiplier result is determined to be inexact. The exception flag may be used to indicate to a system that a significand rounded result (e.g., the significand rounded result of FIG. 5) and/or a final result (e.g., the final result 145 of FIG. 1) is inexact. For example, the exception flag may be generated by the FMUL and/or detected by the processor.

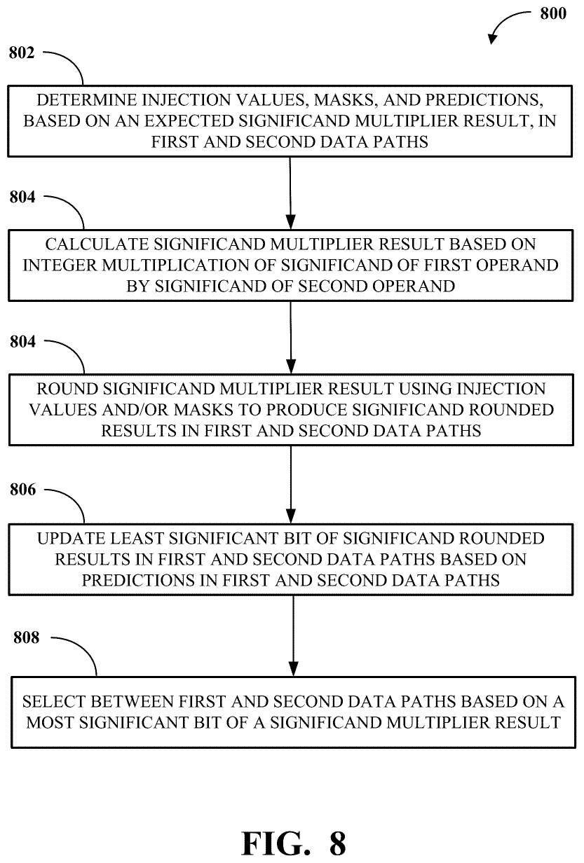

FIG. 8 is a flow chart of an example of another process 800 for using an FMUL using zero counters. The process 800 can be performed, for example, using the systems, hardware, and software described with respect to FIGS. 1-5. The steps, or operations, of the process 800 or another technique, method, process, or algorithm described in connection with the implementations disclosed herein can be implemented directly in hardware, firmware, software executed by hardware, circuitry, or a combination thereof. Further, for simplicity of explanation, although the figures and descriptions herein may include sequences or series of steps or stages, elements of the methods and claims disclosed herein may occur in various orders or concurrently and need not include all of the steps or stages. Additionally, elements of the methods and claims disclosed herein may occur with other elements not explicitly presented and described herein. Furthermore, not all elements of the methods and claims described herein may be required in accordance with this disclosure. Although aspects, features, and elements are described and claimed herein in particular combinations, each aspect, feature, or element may be used and claimed independently or in various combinations with or without other aspects, features, and elements.

The process 800 may include determining 802 injection values, masks, and predictions in a first data path and in a second data path. The injection values, masks, and predictions in the first data path and in the second data path may be based on an expected significand multiplier result. For example, an FMUL (e.g., the FMUL 100) may implement injection, mask, and prediction circuitry in a first data path and in a second data path (e.g., the injection, mask, and prediction circuitry 120A in the first data path and the injection, mask, and prediction circuitry 120B in the second data path). The injection, mask, and prediction circuitry may provide separate outputs corresponding to the first data path and the second data path to rounding and update circuitry that is also in the first data path and in the second data path.

The process 800 may also include calculating 804 an integer multiplication of a significand of a first operand by a significand of a second operand to produce a significand multiplier result. For example, the FMUL 100 may implement a significand multiplier 115 (e.g., in carry-save form) to perform the integer multiplication. The significand multiplier may provide the significand multiplier result in the first data path and the second data path, such as to the rounding and update circuitry that is also in the first data path and in the second data path. The significand multiplier result may be calculated in parallel with the determining of injection values, masks, and predictions in the first data path and in the second data path.

The process 800 may also include rounding 806 the significand multiplier result to produce a significand rounded result in the first data path and in the second data path. For example, rounding and update circuitry (e.g., the rounding and update circuitry 130A in the first data path and rounding and update circuitry 130B in the second data path) may be used. The rounding and update circuitry in the first data path may be used for rounding in the overflow case, and the rounding and update circuitry in the second data path may be used for rounding in the standard case. The rounding and update circuitry may provide separate outputs corresponding to the first data path and the second data path to result selection circuitry (e.g., the result selection circuitry 140).

The process 800 may also include updating 808 the LSB of the significand rounded result in the first data path and in the second data path. For example, the rounding and update circuitry may also include an LSB update circuit (e.g., the LSB update circuit 564). The LSB update circuit may update the LSB of the significand rounded result (e.g., from the rounding circuit 562) when a compare circuit (e.g., the compare circuit 240A in the first data path or the compare circuit 240B in the second data path) determines that the expected significand multiplier result will cause a tie. The update of the LSB of the significand rounded result may be based on the prediction and the masks.

The process 800 may also include selecting 810 between the first and second data paths based on the MSB of the significand multiplier result. For example, the FMUL may implement MSB position circuitry (e.g., the MSB position circuitry 135) to select between separate outputs provided to the result selection circuitry for providing the significand rounded result to be used for a final result (e.g., the final result 145). The MSB position circuitry may select the output to correspond to the first data path (e.g., associated with the overflow case, using the injection, mask, and prediction circuitry and the rounding and update circuitry in the first data path) or the second data path (associated with the standard case, using the injection, mask, and prediction circuitry and the rounding and update circuitry in the second data path) based on the MSB of the significand multiplier result.

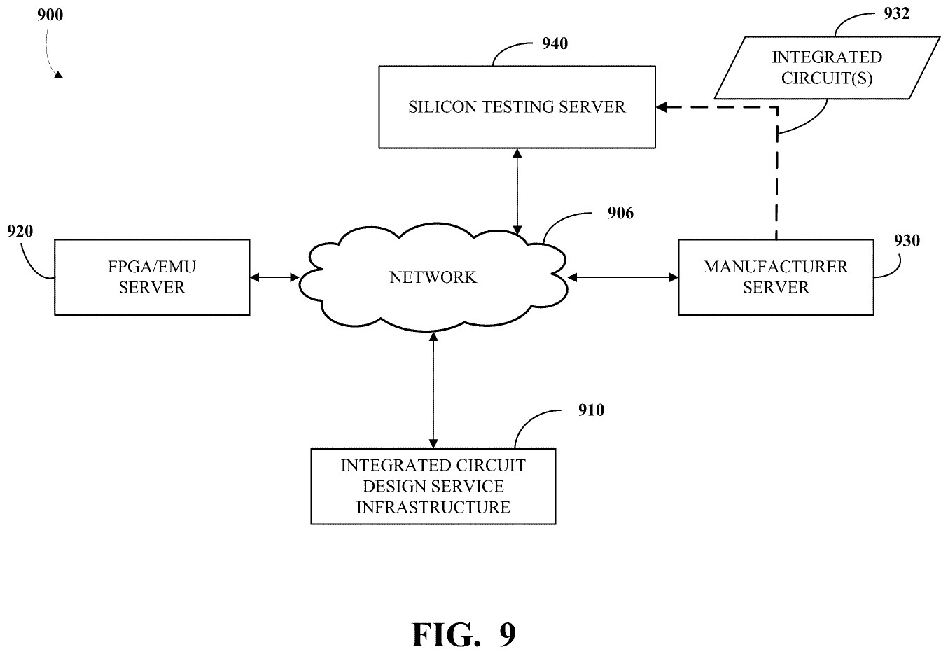

FIG. 9 is a block diagram of an example of a system 900 for generation and manufacture of integrated circuits that configure an FMUL using zero counters. The system 900 includes a network 906, an integrated circuit design service infrastructure 910, a field programmable gate array (FPGA)/emulator server 920, and a manufacturer server 930. For example, a user may utilize a web client or a scripting application program interface (API) client to command the integrated circuit design service infrastructure 910 to automatically generate an integrated circuit design based on a set of design parameter values selected by the user for one or more template integrated circuit designs. In some implementations, the integrated circuit design service infrastructure 910 may be configured to generate an integrated circuit design with that configures an FMUL using zero counters as described in FIGS. 1-8.

The integrated circuit design service infrastructure 910 may include a register-transfer level (RTL) service module configured to generate an RTL data structure for the integrated circuit based on a design parameters data structure. For example, the RTL service module may be implemented as Scala code. For example, the RTL service module may be implemented using Chisel. For example, the RTL service module may be implemented using a flexible intermediate representation for register-transfer level (FIRRTL). For example, the RTL service module may be implemented using Diplomacy. For example, the RTL service module may enable a well-designed chip to be automatically developed from a high level set of configuration settings using a mix of Diplomacy, Chisel, and FIRRTL. The RTL service module may take the design parameters data structure (e.g., a java script object notation (JSON) file) as input and output an RTL data structure (e.g., a Verilog file) for the chip.

In some implementations, the integrated circuit design service infrastructure 910 may invoke (e.g., via network communications over the network 906) testing of the resulting design that is performed by the FPGA/emulation server 920 that is running one or more FPGAs or other types of hardware or software emulators. For example, the integrated circuit design service infrastructure 910 may invoke a test using a field programmable gate array, programmed based on a field programmable gate array emulation data structure, to obtain an emulation result. The field programmable gate array may be operating on the FPGA/emulation server 920, which may be a cloud server. Test results may be returned by the FPGA/emulation server 920 to the integrated circuit design service infrastructure 910 and relayed in a useful format to the user (e.g., via a web client or a scripting API client).

The integrated circuit design service infrastructure 910 may also facilitate the manufacture of integrated circuits using the integrated circuit design in a manufacturing facility associated with the manufacturer server 930. In some implementations, a physical design specification (e.g., a graphic data system (GDS) file, such as a GDSII file) based on a physical design data structure for the integrated circuit is transmitted to the manufacturer server 930 to invoke manufacturing of the integrated circuit (e.g., using manufacturing equipment of the associated manufacturer). For example, the manufacturer server 930 may host a foundry tape-out website that is configured to receive physical design specifications (e.g., such as a GDSII file or an open artwork system interchange standard (OASIS) file) to schedule or otherwise facilitate fabrication of integrated circuits. In some implementations, the integrated circuit design service infrastructure 910 supports multi-tenancy to allow multiple integrated circuit designs (e.g., from one or more users) to share fixed costs of manufacturing (e.g., reticle/mask generation, and/or shuttles wafer tests). For example, the integrated circuit design service infrastructure 910 may use a fixed package (e.g., a quasi-standardized packaging) that is defined to reduce fixed costs and facilitate sharing of reticle/mask, wafer test, and other fixed manufacturing costs. For example, the physical design specification may include one or more physical designs from one or more respective physical design data structures in order to facilitate multi-tenancy manufacturing.

In response to the transmission of the physical design specification, the manufacturer associated with the manufacturer server 930 may fabricate and/or test integrated circuits based on the integrated circuit design. For example, the associated manufacturer (e.g., a foundry) may perform optical proximity correction (OPC) and similar post—tape-out/pre-production processing, fabricate the integrated circuit(s) 932, update the integrated circuit design service infrastructure 910 (e.g., via communications with a controller or a web application server) periodically or asynchronously on the status of the manufacturing process, perform appropriate testing (e.g., wafer testing), and send to a packaging house for packaging. A packaging house may receive the finished wafers or dice from the manufacturer and test materials and update the integrated circuit design service infrastructure 910 on the status of the packaging and delivery process periodically or asynchronously. In some implementations, status updates may be relayed to the user when the user checks in using the web interface, and/or the controller might email the user that updates are available.

In some implementations, the resulting integrated circuit(s) 932 (e.g., physical chips) are delivered (e.g., via mail) to a silicon testing service provider associated with a silicon testing server 940. In some implementations, the resulting integrated circuit(s) 932 (e.g., physical chips) are installed in a system controlled by the silicon testing server 940 (e.g., a cloud server), making them quickly accessible to be run and tested remotely using network communications to control the operation of the integrated circuit(s) 932. For example, a login to the silicon testing server 940 controlling a manufactured integrated circuit(s) 932 may be sent to the integrated circuit design service infrastructure 910 and relayed to a user (e.g., via a web client). For example, the integrated circuit design service infrastructure 910 may be used to control testing of one or more integrated circuit(s) 932, which may be structured based on a design determined according to FIGS. 1-8.

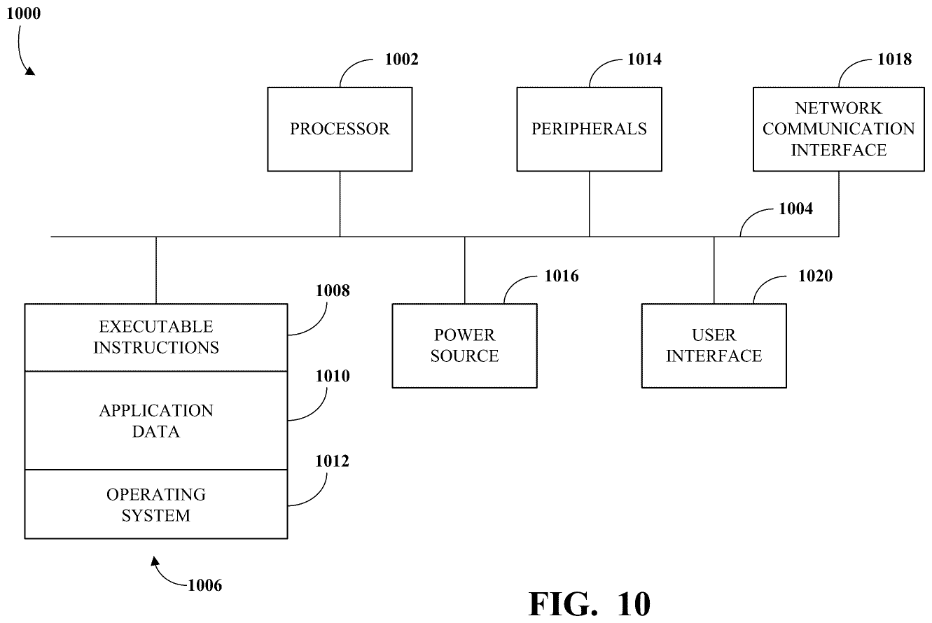

FIG. 10 is a block diagram of an example of a system 1000 for facilitating generation of integrated circuits that configure an FMUL using zero counters, for facilitating generation of a circuit representation for an integrated circuit, and/or for programming or manufacturing an integrated circuit. The system 1000 is an example of an internal configuration of a computing device that may be used to implement the integrated circuit design service infrastructure 910, and/or to generate a file that generates a circuit representation of an integrated circuit design as described in FIGS. 1-8. The system 1000 can include components or units, such as a processor 1002, a bus 1004, a memory 1006, peripherals 1014, a power source 1016, a network communication interface 1018, a user interface 1020, other suitable components, or a combination thereof.

The processor 1002 can be a CPU, such as a microprocessor, and can include single or multiple processors having single or multiple processing cores. Alternatively, the processor 1002 can include another type of device, or multiple devices, now existing or hereafter developed, capable of manipulating or processing information. For example, the processor 1002 can include multiple processors interconnected in any manner, including hardwired or networked, including wirelessly networked. In some implementations, the operations of the processor 1002 can be distributed across multiple physical devices or units that can be coupled directly or across a local area or other suitable type of network. In some implementations, the processor 1002 can include a cache, or cache memory, for local storage of operating data or instructions.

The memory 1006 can include volatile memory, non-volatile memory, or a combination thereof. For example, the memory 1006 can include volatile memory, such as one or more dynamic random access memory (DRAM) modules such as double data rate (DDR) synchronous DRAM (SDRAM), and non-volatile memory, such as a disk drive, a solid-state drive, flash memory, Phase-Change Memory (PCM), or any form of non-volatile memory capable of persistent electronic information storage, such as in the absence of an active power supply. The memory 1006 can include another type of device, or multiple devices, now existing or hereafter developed, capable of storing data or instructions for processing by the processor 1002. The processor 1002 can access or manipulate data in the memory 1006 via the bus 1004. Although shown as a single block in FIG. 10, the memory 1006 can be implemented as multiple units. For example, a system 1000 can include volatile memory, such as random access memory (RAM), and persistent memory, such as a hard drive or other storage.

The memory 1006 can include executable instructions 1008, data, such as application data 1010, an operating system 1012, or a combination thereof, for immediate access by the processor 1002. The executable instructions 1008 can include, for example, one or more application programs, which can be loaded or copied, in whole or in part, from non-volatile memory to volatile memory to be executed by the processor 1002. The executable instructions 1008 can be organized into programmable modules or algorithms, functional programs, codes, code segments, or combinations thereof to perform various functions described herein. For example, the executable instructions 1008 can include instructions executable by the processor 1002 to cause the system 1000 to automatically, in response to a command, generate an integrated circuit design and associated test results based on a design parameters data structure. The application data 1010 can include, for example, user files, database catalogs or dictionaries, configuration information or functional programs, such as a web browser, a web server, a database server, or a combination thereof. The operating system 1012 can be, for example, Microsoft Windows®, macOS®, or Linux®, an operating system for a small device, such as a smartphone or tablet device; or an operating system for a large device, such as a mainframe computer. The memory 1006 can comprise one or more devices and can utilize one or more types of storage, such as solid-state or magnetic storage.

The peripherals 1014 can be coupled to the processor 1002 via the bus 1004. The peripherals 1014 can be sensors or detectors, or devices containing any number of sensors or detectors, which can monitor the system 1000 itself or the environment around the system 1000. For example, a system 1000 can contain a temperature sensor for measuring temperatures of components of the system 1000, such as the processor 1002. Other sensors or detectors can be used with the system 1000, as can be contemplated. In some implementations, the power source 1016 can be a battery, and the system 1000 can operate independently of an external power distribution system. Any of the components of the system 1000, such as the peripherals 1014 or the power source 1016, can communicate with the processor 1002 via the bus 1004.

The network communication interface 1018 can also be coupled to the processor 1002 via the bus 1004. In some implementations, the network communication interface 1018 can comprise one or more transceivers. The network communication interface 1018 can, for example, provide a connection or link to a network, such as the network 906 shown in FIG. 9, via a network interface, which can be a wired network interface, such as Ethernet, or a wireless network interface. For example, the system 1000 can communicate with other devices via the network communication interface 1018 and the network interface using one or more network protocols, such as Ethernet, transmission control protocol (TCP), Internet protocol (IP), power line communication (PLC), wireless fidelity (Wi-Fi), infrared, general packet radio service (GPRS), global system for mobile communications (GSM), code division multiple access (CDMA), or other suitable protocols.

A user interface 1020 can include a display; a positional input device, such as a mouse, touchpad, touchscreen, or the like; a keyboard; or other suitable human or machine interface devices. The user interface 1020 can be coupled to the processor 1002 via the bus 1004. Other interface devices that permit a user to program or otherwise use the system 1000 can be provided in addition to or as an alternative to a display. In some implementations, the user interface 1020 can include a display, which can be a liquid crystal display (LCD), a cathode-ray tube (CRT), a light emitting diode (LED) display (e.g., an organic light emitting diode (OLED) display), or other suitable display. In some implementations, a client or server can omit the peripherals 1014. The operations of the processor 1002 can be distributed across multiple clients or servers, which can be coupled directly or across a local area or other suitable type of network. The memory 1006 can be distributed across multiple clients or servers, such as network-based memory or memory in multiple clients or servers performing the operations of clients or servers. Although depicted here as a single bus, the bus 1004 can be composed of multiple buses, which can be connected to one another through various bridges, controllers, or adapters.

A non-transitory computer readable medium may store a circuit representation that, when processed by a computer, is used to program or manufacture an integrated circuit. For example, the circuit representation may describe the integrated circuit specified using a computer readable syntax. The computer readable syntax may specify the structure or function of the integrated circuit or a combination thereof. In some implementations, the circuit representation may take the form of a hardware description language (HDL) program, an RTL data structure, a flexible intermediate representation for register-transfer level (FIRRTL) data structure, a Graphic Design System II (GDSII) data structure, a netlist, or a combination thereof. In some implementations, the integrated circuit may take the form of an FPGA, an ASIC, an SoC, or some combination thereof. A computer may process the circuit representation in order to program or manufacture an integrated circuit, which may include programming an FPGA or manufacturing an ASIC or an SoC. In some implementations, the circuit representation may comprise a file that, when processed by a computer, may generate a new description of the integrated circuit. For example, the circuit representation could be written in a language such as Chisel, an HDL embedded in Scala, a statically typed general purpose programming language that supports both object-oriented programming and functional programming.

In an example, a circuit representation may be a Chisel language program which may be executed by the computer to produce a circuit representation expressed in a FIRRTL data structure. In some implementations, a design flow of processing steps may be utilized to process the circuit representation into one or more intermediate circuit representations followed by a final circuit representation which is then used to program or manufacture an integrated circuit. In one example, a circuit representation in the form of a Chisel program may be stored on a non-transitory computer readable medium and may be processed by a computer to produce a FIRRTL circuit representation. The FIRRTL circuit representation may be processed by a computer to produce an RTL circuit representation. The RTL circuit representation may be processed by the computer to produce a netlist circuit representation. The netlist circuit representation may be processed by the computer to produce a GDSII circuit representation. The GDSII circuit representation may be processed by the computer to produce the integrated circuit.

In another example, a circuit representation in the form of Verilog or VHDL may be stored on a non-transitory computer readable medium and may be processed by a computer to produce an RTL circuit representation. The RTL circuit representation may be processed by the computer to produce a netlist circuit representation. The netlist circuit representation may be processed by the computer to produce a GDSII circuit representation. The GDSII circuit representation may be processed by the computer to produce the integrated circuit. The foregoing steps may be executed by the same computer, different computers, or some combination thereof, depending on the implementation.

As used herein, the term “circuitry” refers to an arrangement of electronic components (e.g., transistors, resistors, capacitors, and/or inductors) that is structured to implement one or more functions. For example, a circuit may include one or more transistors interconnected to form logic gates that collectively implement a logical function. While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures.

What is claimed is:

1. An integrated circuit comprising:
a processor implementing a floating-point multiplier (FMUL) configured to multiply a first operand by a second operand to produce a final result, wherein the FMUL uses:
one or more zero counters configured to count trailing zeros of a significand of the first operand and trailing zeros of a significand of the second operand to produce a trailing zero count from the first operand and the second operand;
a round-bit position circuit configured to determine a predicted round-bit position of an expected significand multiplier result produced by an integer multiplication of the significand of the first operand by the significand of the second operand, wherein the predicted round-bit position is used to determine a trailing bit count indicating a number of bits that are less significant than the predicted round-bit position; and
a compare circuit configured to compare the trailing zero count to the trailing bit count to determine whether the expected significand multiplier result will cause a tie when rounding the expected significand multiplier result to produce the final result.

2. The integrated circuit of claim 1, wherein the compare circuit is configured to indicate the tie when the trailing zero count is equal to the trailing bit count.

3. The integrated circuit of claim 1, wherein the compare circuit is configured to indicate that the expected significand multiplier result is inexact when the trailing zero count is less than the trailing bit count.

4. The integrated circuit of claim 1, wherein the round-bit position circuit and the compare circuit are a first round-bit position circuit and a first compare circuit in a first data path in which a most significant bit (MSB) of the expected significand multiplier result is assumed to be one, and further comprising a second round-bit position circuit and a second compare circuit in a second data path in which the MSB of the expected significand multiplier result is assumed to be zero.

5. An apparatus comprising:
one or more zero counters configured to count trailing zeros of a significand of a first operand and trailing zeros of a significand of a second operand to produce a trailing zero count from the first operand and the second operand;
a round-bit position circuit configured to determine a predicted round-bit position of an expected significand multiplier result produced by an integer multiplication of the significand of the first operand by the significand of the second operand, wherein the predicted round-bit position is used to determine a trailing bit count indicating a number of bits that are less significant than the predicted round-bit position; and
a compare circuit configured to compare the trailing zero count to the trailing bit count to determine whether the expected significand multiplier result will cause a tie when rounding.

6. The apparatus of claim 5, wherein the compare circuit is configured to indicate the tie when the trailing zero count is equal to the trailing bit count.

7. The apparatus of claim 5, wherein the compare circuit is configured to indicate that the expected significand multiplier result is inexact when the trailing zero count is less than the trailing bit count.

8. The apparatus of claim 5, wherein the round-bit position circuit and the compare circuit are a first round-bit position circuit and a first compare circuit in a first data path, and further comprising a second round-bit position circuit and a second compare circuit in a second data path, wherein one of the first data path or the second data path is selected based on a most significant bit (MSB) of a significand multiplier result produced by an integer multiplication of the significand of the first operand by the significand of the second operand.

9. The apparatus of claim 5, further comprising:
a significand multiplier configured to calculate an integer multiplication of the significand of the first operand by the significand of the second operand to produce a significand multiplier result, wherein the compare circuit is configured to determine the tie in parallel with the significand multiplier calculating the significand multiplier result.

10. The apparatus of claim 5, further comprising:
an injection value circuit configured to determine an injection value;
a rounding circuit configured to receive the injection value and a significand multiplier result produced by an integer multiplication of the significand of the first operand by the significand of the second operand and add the injection value to the significand multiplier result to produce a significand rounded result; and
a least significant bit (LSB) update circuit configured to update an LSB of the significand rounded result when the compare circuit determines the tie.

11. The apparatus of claim 5, wherein the one or more zero counters, the round-bit position circuit, and the compare circuit are used by a floating-point multiplier (FMUL) to multiply the first operand by the second operand to produce a final result using a rounding mode to round the final result to a nearest value with the tie going to an even value.

12. The apparatus of claim 5, wherein the first operand and the second operand are in a recoded format in which the first operand and the second operand are associated with a one in an MSB position.

13. The apparatus of claim 5, wherein:
the one or more zero counters are further configured to count leading zeros of the significand of the first operand and leading zeros of the significand of the second operand to produce a leading zero count from the first operand and the second operand, wherein at least one of the first operand or the second operand is associated with a sub-normal number, and wherein the leading zero count is used to determine an MSB of the expected significand multiplier result.

14. The apparatus of claim 5, wherein the one or more zero counters comprise a first zero counter configured to count trailing zeros of the significand of the first operand to produce a first trailing zero count and a second zero counter configured to count trailing zeros of the significand of the second operand to produce a second trailing zero count, wherein the first trailing zero count and the second trailing zero count are added to produce the trailing zero count.

15. The apparatus of claim 5, wherein the predicted round-bit position is determined by summing an exponent of the first operand with an exponent of the second operand.

16. A method comprising:
counting trailing zeros of a significand of a first operand and trailing zeros of a significand of a second operand to produce a trailing zero count from the first operand and the second operand;
determining a predicted round-bit position of an expected significand multiplier result produced by an integer multiplication of the significand of the first operand by the significand of the second operand, wherein the predicted round-bit position is used to determine a trailing bit count indicating a number of bits that are less significant than the predicted round-bit position; and
comparing the trailing zero count to the trailing bit count to determine whether the expected significand multiplier result will cause a tie when rounding.

17. The method of claim 16, further comprising indicating the tie when the trailing zero count is equal to the trailing bit count.

18. The method of claim 16, further comprising indicating that the expected significand multiplier result is inexact when the trailing zero count is less than the trailing bit count.

19. The method of claim 16, further comprising:
determining the tie in a first data path in which a most significant bit (MSB) of the expected significand multiplier result is assumed to be one and in a second data path in which the MSB of the expected significand multiplier result is assumed to be zero; and
selecting, based on an MSB of a significand multiplier result produced by an integer multiplication of the significand of the first operand by the significand of the second operand, the first data path or the second data path.

20. The method of claim 16, further comprising:
calculating an integer multiplication of the significand of the first operand by the significand of the second operand to produce a significand multiplier result; and
determining the tie in parallel with calculating the significand multiplier result.
